(19) United States
(12) Patent Application Publication
(10) Pub. No.: US 2008/0077889 A1
(43) Pub. Date: Mar. 27, 2008

(54) PARAMETERIZED SEMICONDUCTOR CHIP CELLS AND OPTIMIZATION OF THE SAME

(75) Inventors: Erwin Behnen, Austin, TX (US); Gregory A. Northrop, Putnam Valley, NY (US); James D. Warnock, Somers, NY (US); Dieter Wendel, Schoenaich (DE); Pieter Joseph Woeltgens, Yorktown Heights, NY (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/533,814

(22) Filed: Sep. 21, 2006

(51) Int. Cl. G06F 17/50

(52) U.S. Cl. 716/2

(57) ABSTRACT

A method is provided for designing an integrated circuit utilizing an arrangement of at least one library cell having a plurality of parameterized input connection points disposed along a rod, a plurality of parameterized output connection points disposed along a wire and a cell structure to which the rod and wire are electrically connected; routing and making input and output connections to the library cells at the parameterized input connection points and the parameterized output connection points to satisfy design specifications of the integrated circuit. After determining which parameterized input connection points and parameterized output connection points are unused, the unused parameterized input connection points and parameterized output connection points are removed from each library cell of the integrated circuit design.

### BACKGROUND OF THE INVENTION

1. Field of the Invention

This invention relates to integrated circuit design, and particularly to an improved method for optimizing electrical connections within an integrated circuit design.

2. Description of Background

In the design of standard cell based integrated circuits (IC's), a standard cell library is a quantity of cells designed to be used repetitively throughout the design of the IC. However, the standard cell library may be a limiting factor in standard cell based IC design because the standard cell library may not offer the necessary variety of cells to meet the same performance requirements and/or size constraints that can be achieved through a fully custom IC design.

One way to achieve a greater degree of flexibility in IC design using a standard cell library is to design each standard library cell with multiple input connection points and output connection points. Providing multiple connection points can ease wiring congestion over portions of a cell. For example, if wiring congestion over one portion of a cell would make a connection to one of the connection points difficult, one of the other connection points could be used.

The use of standard library cells having multiple input connection points and multiple output connection points does have disadvantages, though. For example, to create the multiple connection points, additional shapes must be added to the cell structure. The added shapes that are not used cause increased parasitic capacitance in the cell, which will have a negative effect on the performance of the IC. Additionally, product yield may be reduced, since the probability that a defect in one of the added shapes may create a short to a neighboring structure will increase.

What is needed is an IC design that tales advantage of the flexibility and optimization potential of standard library cells with multiple input connection points and multiple output connection points, without sacrificing the performance or yield of the IC.

### SUMMARY OF THE INVENTION

The shortcomings of the prior art are overcome and additional advantages are provided through the provision of an improved library cell for integrated circuit design comprising a plurality of parameterized input connection points disposed along a rod, a plurality of parameterized output connection points disposed along a wire; and a cell structure to which the rod and wire are electrically connected.

A method is provided for designing an integrated circuit utilizing an arrangement of at least one library cell having a plurality of parameterized input connection points disposed along a rod, a plurality of parameterized output connection points disposed along a wire and a cell structure to which the rod and wire are electrically connected; routing and making input and output connections to the library cells at the parameterized input connection points and the parameterized output connection points to satisfy design specifications of the integrated circuit. After determining which parameterized input connection points and parameterized output connection points are unused, the unused parameterized input connection points and parameterized output connection points are removed from each individual instance of each library cell of the integrated circuit design.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically a solution has been achieved which increases the flexibility of a standard cell library so that fewer custom cells may be required in an integrated circuit design. Additionally, the invention disclosed reduces parasitic capacitance thereby increasing performance and yield of the integrated circuit, while also lowering the power consumed during operation of the circuit.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a plan view of one example of a library cell with multiple input contacts and multiple output connection points.

FIG. 2 is a block diagram describing one example of a process for optimizing the input and output connections within an integrated circuit.

FIG. 3 is a plan view of one example of a library cell with input and output connections made thereto.

FIG. 4 is a plan view of one example of a library cell with input and output connections made thereto, and with unused input contacts and unused output connection points removed.

The detailed description explains the preferred embodiments of the invention, together with advantages and features, by way of example with reference to the drawings.

### DETAILED DESCRIPTION OF THE INVENTION

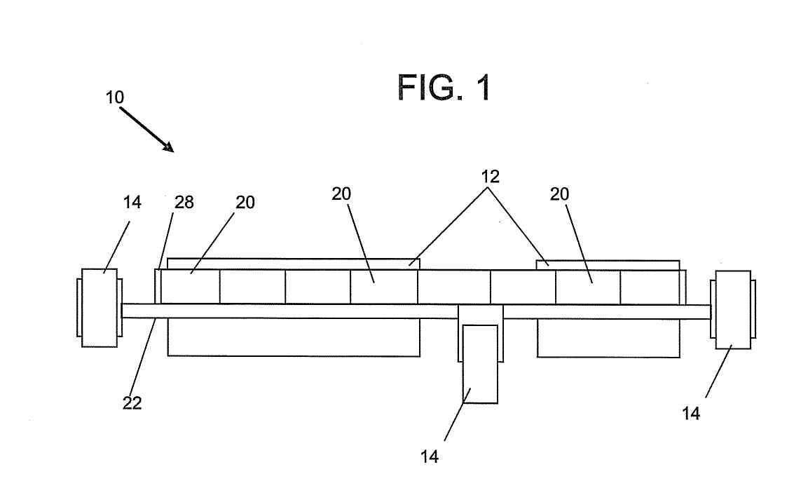

Turning now to the drawings in greater detail, it will be seen that in FIG. 1 there is an embodiment of a library cell 10 having a plurality of input connection contacts 14 and having a plurality of output connection points 20. The plurality of input connection contacts 14 is disposed along an input connection rod 22, which is electrically connected to a cell structure 12. The plurality of output connection points 20 are disposed along an output connection metal 28 which is electrically connected to the cell structure 12. An integrated circuit (not shown) comprises a plurality of library cells 10 electrically interconnected by input connections and output connections at respective input connection contacts 14 and output connection points 20.

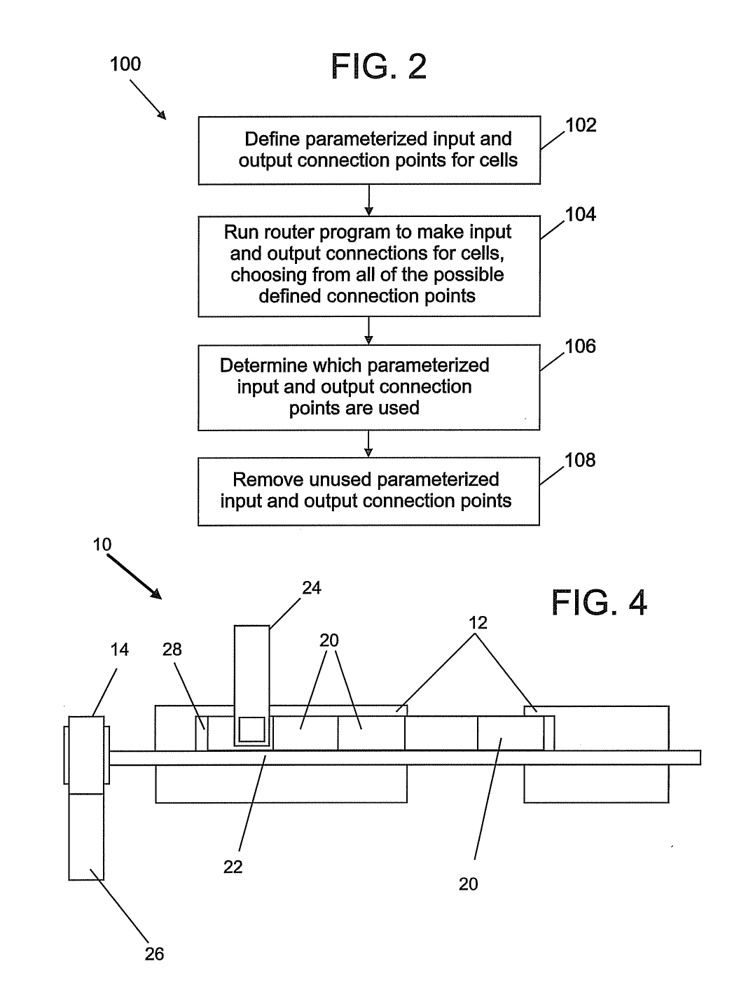

An example of a method 100 of optimizing the electrical connections between each library cell 10 and each other library cell 10 in the integrated circuit is illustrated in FIG. 2. First, as described in block 102, parameterized input connection contacts 14 and parameterized output connection points 20 are defined. Next, in block 104, a router program is run which makes input connections and output connections to the cells as required. The next process, block 106, determines which of the parameterized input contacts 14 and parameterized output points 20 are unused by the router program. Finally, as described in block 108, the unused parameterized input connection contacts 14 and the unused parameterized output connection points 20 are removed.

Block 102 of FIG. 2 describes defining parameterized input connection contacts 14 and parameterized output connection points 20 for each library cell 10 in the integrated circuit. Referring again to FIG. 1, the input connection contacts 14 and the output connection points 20 are parameterized (i.e., designated with descriptive parameter properties), with the parameter properties in this embodiment relating to the location of the input connection contact 14 or the output connection point 20. For example, the library cell 10 shown in FIG. 1 may have parameters input (“left”, “center”, “right”) to define the three input connection contact parameters corresponding to a left, center, and right input connection contact, respectively. Additionally, the library cell 10 may have parameters output (“X₁”, “X₂”, “X₃”, “X₄”, “X₅”, “X₆”, “X₇”, “X₈”) defining the eight output connection point parameters corresponding to eight discrete output connection points 20 along the output connection metal 28.

Each parameterized input connection contact 14 and each parameterized output connection point 20 may be turned “on”, meaning that the particular point is available for connection to, or turned “off”, meaning that the particular point is unavailable for connection to. During an initial design process of an integrated circuit (IC), a maximum number of parameterized input connection contacts 14 and parameterized output connection points 20 are turned “on”.

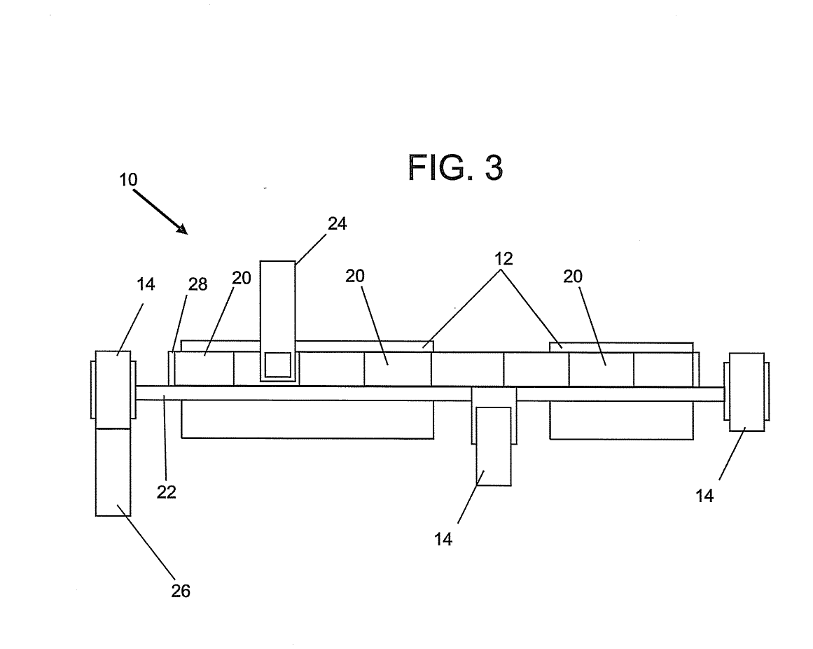

Next, as described in block 104 of FIG. 2, an automated router program determines which parameterized input connection contacts 14 and parameterized output connection points 20 to utilize in making connections between the individual library cells 10 of the IC. As shown in FIG. 3, the router program makes an input connection 26 and an output connection 24 to a corresponding input connection contact 14 and output connection point 20. The process is repeated for each input connection 26 and output connection 24 in the IC. By enabling the router program to choose from the available parameterized input connection contacts 14 and the available parameterized output connection points 20, the wiring routing is optimized by increasing efficiency of the routing and minimizing over congestion of wiring connections in any one area of the IC.

As described in block 106 of FIG. 2, once an input connection 26 and an output connection 24 is made, a determination is made of which parameterized input connection contacts 14 and which parameterized output connection points 20 are left unused by the router program. Finally, as described in block 108, the unused parameterized input connection contacts 14 and the unused parameterized output connection points 20 are removed. As shown if FIG. 4, the remaining unused input connection contacts 14 and unused output connect points 20 are removed, making sure to leave a portion of the output connection metal 28 necessary to connect a first portion of the cell structure 12 to a second portion of the cell structure 12. Removing the unused input connection contacts 14 and the unused output connection points 20 advantageously reduces parasitic capacitance in the integrated circuit. Yield may also be increased since, if left intact, the unused input connection contacts 14 and the unused output connection points 20 may introduce a defect creating a short to neighboring structures.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code points for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While embodiments of the invention have been described, it will be understood that those skilled in the art, both now and in the future, may make various improvements and enhancements which fall within the scope of the claims which follow. These claims should be construed to maintain the proper protection for the invention first described.

What is claimed is:

1. A method for optimizing connections within an integrated circuit design comprising:
defining a plurality of parameterized input connection points and a plurality of parameterized output connection points on each cell of an integrated circuit;
running a router program to select specific input and output connections to the cells of the integrated circuit from each of the defined parameterized input connection points and parameterized output connection points;
determining which parameterized input connection points and which parameterized output connection points are unused by the router program; and
removing the unused parameterized input connection points and unused parameterized output connection points from each cell of the integrated circuit.

2. The method of claim 1 wherein the parameter properties of the parameterized input connection points relate to the parameterized input connection points' location thereof on the library cell.

3. The method of claim 1 wherein the parameter properties of the parameterized output connection points relate to the parameterized output connection points' location thereof on the library cell.

4. The method of claim 1 wherein the input connection points are electrically connected to a conductive input connection rod.

5. The method of claim 4 wherein the conductive input connection rod is electrically connected to a cell structure.

6. The method of claim 1 wherein the output connection points are electrically connected to a conductive output connection wire.

7. The method of claim 6 wherein the conductive output connection wire is electrically connected to a cell structure.

8. A program storage device readable by a computer, the device embodying a program or instructions executable by the computer to perform a method comprising:
defining a plurality of parameterized input connection points and a plurality of parameterized output connection points on each cell of an integrated circuit;
running a router program to select specific input and output connections to the cells of the integrated circuit from each of the defined parameterized input connection points and parameterized output connection points;
determining which parameterized input connection points and which parameterized output connection points are unused by the router program; and
removing the unused parameterized input connection points and unused parameterized output connection points from each cell of the integrated circuit.

9. The method of claim 8 wherein the parameter properties of the parameterized input connection points relate to the parameterized input connection points' location thereof on the library cell.

10. The method of claim 8 wherein the parameter properties of the parameterized output connection points relate to the parameterized output connection points' location thereof on the library cell.

11. The method of claim 8 wherein the input connection points are electrically connected to a conductive input connection rod.

12. The method of claim 11 wherein the conductive input connection rod is electrically connected to a cell structure.

13. The method of claim 8 wherein the output connection points are electrically connected to a conductive output connection wire.

14. The method of claim 13 wherein the conductive output connection wire is electrically connected to a cell structure.
